(19) United States
(12) Patent Application Publication
(10) Pub. No.: US 2025/0042791 A1
(43) Pub. Date: Feb. 6, 2025

(54) EXTERNAL ACCELERATION SYSTEM FOR BIOLOGICAL DENITRIFICATION PROCESS DURING WASTEWATER TREATMENT

(71) Applicant: SUN YAT-SEN UNIVERSITY, Guangzhou City (CN)

(72) Inventors: Feng JIANG, Guangzhou (CN); Yanying QIU, Guangzhou (CN); Xiaolan CAI, Guangzhou (CN)

(73) Assignee: SUN YAT-SEN UNIVERSITY, Guangzhou City (CN)

(21) Appl. No.: 18/789,752

(22) Filed: Jul. 31, 2024

(30) Foreign Application Priority Data
Jul. 31, 2023 (CN) 202310948749.8

(51) Int. Cl. C02F 3/30; C02F 101/16

(52) U.S. Cl. CPC C02F 3/305; C02F 2101/163; C02F 2203/006; C02F 2209/06; C02F 2209/15

(57) ABSTRACT

Disclosed is an external acceleration system for a biological denitrification process during wastewater treatment, including a biological denitrification mechanism, a denitrification acceleration mechanism, and a water circulation mechanism, where the biological denitrification mechanism includes a biological denitrification tank, a three-way valve, a wastewater assembly, and a water inlet pipe; the denitrification acceleration mechanism includes a denitrification accelerator and an assembly for enhancing the sulfur disproportionation reaction; the water circulation mechanism includes a first water delivery pump, a first water delivery pipe, a second water delivery pipe, and a second water delivery pump. The external acceleration system for a biological denitrification process during wastewater treatment spatially and temporally separates the sulfur disproportionation reaction process from the biological denitrification process so that the two processes do not interfere with each other and mutually promote the denitrification effect, which is beneficial to ensure the high efficiency and stability of the denitrification effect. The independently provided denitrification accelerator releases the coupling of the sulfur disproportionation reaction and the autotrophic denitrification reaction in the related art and has a high adaptability to various denitrification systems.

### CROSS-REFERENCE TO RELATED APPLICATIONS

This application claims the right of priority to Chinese Patent Application No. CN 202310948749.8, filed on Jul. 31, 2023, the contents of which are incorporated by reference in its entirety.

### FIELD

The present disclosure relates to the technical field of denitrification, and particularly to an external acceleration system for biological denitrification processes during wastewater treatment.

### BACKGROUND

The current wastewater treatment systems face great challenges in realizing efficient and advanced removal of nitrate nitrogen in wastewater. Currently, the heterotrophic denitrification process with organic carbon source as electron donors is most commonly used in the wastewater denitrification process. Although the heterotrophic denitrification process has a fast reaction rate, it requires the addition of the organic carbon source as the electron donor, resulting in the increase in operating costs and carbon dioxide emissions.

The elemental sulfur-based autotrophic denitrification technology developed in recent years is an important method to solve the problem of advanced denitrification during wastewater treatment. It could reduce the operational cost and carbon dioxide emission of a biological denitrification process by replacing expensive organic carbon with cheap elemental sulfur (S⁰). However, the application and popularization of this technology is limited by the low rate of denitrification caused by the poor bioavailability of S⁰. Unlike elemental sulfur, the sulfide (S²⁻, HS⁻, and H₂S)-based denitrification process may realize efficient denitrification. However, sulfide agents are expensive, and there are safety risks in transport and storage processes. Thus, achieving controlled in-situ sulfide generation at a low cost is the best technical option.

The sulfur disproportionation reaction is a biochemical reaction process mediated by autotrophic sulfur-disproportionating bacteria, which may convert S⁰ into sulfide and sulfate (Formula 1). Sulfide may synthesize polysulfide (Sₙ²⁻) with S⁰ in neutral to alkaline environments (Formula 2), and the polysulfide is a soluble zero-valence sulfur polymer with high bioavailability. Once generated, HS⁻ and Sₙ²⁻ can be rapidly utilized by sulfur-oxidizing denitrifying bacteria to realize rapid nitrate reduction (Formulas 3 and 4). Therefore, the sulfur disproportionation reactor could be used as an accelerator for denitrification, providing efficient electron donors for the denitrification reaction.

$$4 {S}^{0} + 4 {H}_{2} O \to {SO}_{4}^{2 -} + 3 {HS}^{-} + 5 {H}^{+} \qquad ( 1 )$$

$${HS}^{-} + \frac{n - 1}{8} {S}_{8} ↔ {S}_{n}^{2 -} + {H}^{+} \qquad ( 2 )$$

$${S}^{2 -} + 1.6 {NO}_{3}^{-} + 1.6 {H}^{+} \to {SO}_{4}^{2 -} + 0.8 {N}_{2} + 0.8 {H}_{2} O \qquad ( 3 )$$

$${S}_{n}^{2 -} + 6 {NO}_{3}^{-} + 2 {H}_{2} O \to {S}_{n - 5}^{2 -} + 5 {SO}_{4}^{2 -} + 3 {N}_{2} + 4 {H}^{+} \qquad ( 4 )$$

Currently, the existing technology of coupling the sulfur-based autotrophic denitrification reaction with the sulfur disproportionation reaction to achieve advanced denitrification during wastewater treatment is available on the laboratory scale. The above-mentioned reactions may accelerate the denitrification process by sulfur-disproportionating bacteria, which can be achieved by adjusting parameters such as nitrate loading and hydraulic retention time. However, in practical engineering, the fluctuation of real wastewater quality and quantity is difficult to control accurately, and the stability of the system of double-bacteria cooperation and multi-reaction coupling is not good. In addition, the optimum growth conditions of the two bacteria are different. The sulfur-disproportionating bacteria require sufficient alkalinity and an anaerobic environment for growth and metabolism, while the denitrifying bacteria require nitrate and an anoxic environment for growth. The distinct environmental requirements make it challenging to achieve harmonious coexistence. These factors easily impact the activity of the sulfur-disproportionating bacteria, leading to the instability of the sulfur disproportionation reaction, thereby affecting the acceleration effect of denitrification and denitrification efficiency.

Therefore, the present disclosure constructs a system for decoupling a sulfur disproportionation reaction with a sulfur-based autotrophic denitrification reaction and provides an external apparatus for the sulfur disproportionation reaction to avoid interference with the denitrifying bacteria. Meanwhile, the sulfide and polysulfide generated by the sulfur disproportionation reaction can accelerate the denitrification reaction. In this way, the disadvantages of mutual interference of the two bacteria in the same system can be avoided, and the optimal conditions for the two bacteria can also be provided separately to realize the simultaneous acceleration of the denitrification reaction and the sulfur disproportionation reaction.

### SUMMARY

In order to overcome the above-mentioned deficiencies existing in the related art, the object of the present disclosure is to provide an external acceleration system for a biological denitrification process during wastewater treatment so as to release the coupling of a sulfur-based autotrophic denitrification reaction and the sulfur disproportionation reaction, avoiding the problem of the instability of the denitrification acceleration effect caused by mutual interference of sulfur-disproportionating bacteria and denitrifying bacteria as well as the fluctuation of the wastewater quality and quantity, thereby improving the denitrification efficiency.

### BRIEF DESCRIPTION OF THE FIGURES

FIG. 1 is a process flowchart of an external acceleration system for a biological denitrification process during wastewater treatment according to the present disclosure;

FIG. 2 is a schematic diagram of an external acceleration system for a biological denitrification process during wastewater treatment according to the present disclosure;

FIG. 3 is a schematic diagram of an external acceleration system for a biological denitrification process during wastewater treatment according to the present disclosure.

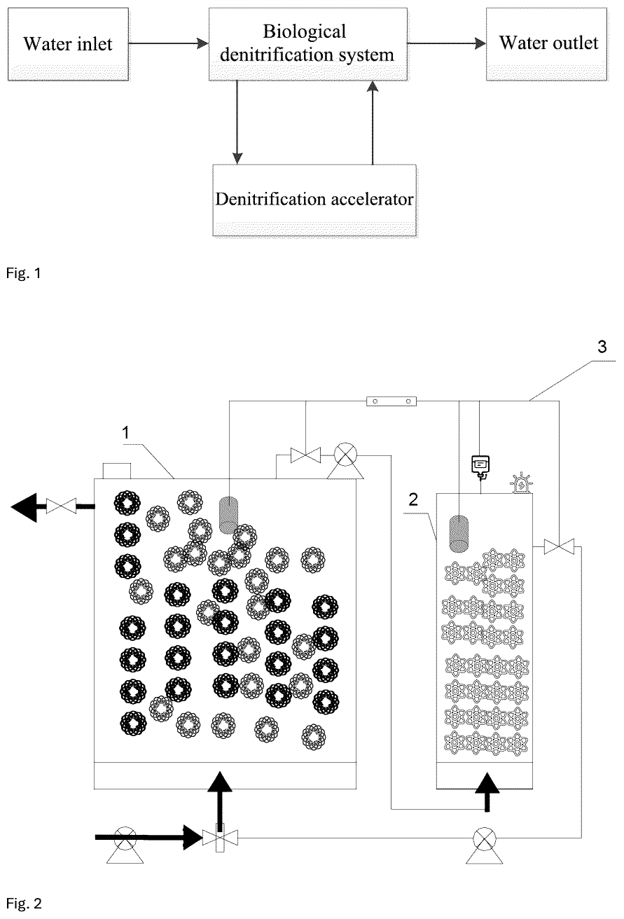

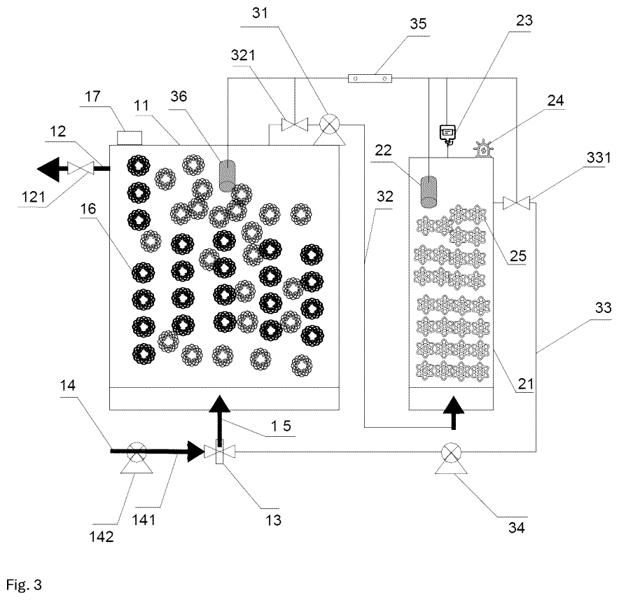

Marks of parts in the drawings: 1—biological denitrification mechanism, 11—biological denitrification tank, 12—water outlet pipe, 121—water outlet stop valve, 13—three-way valve, 14—wastewater assembly, 141—wastewater pipe, 142—wastewater pump, 15—water inlet pipe, 16—biological denitrification filler, 17—exhaust port, 2—denitrification acceleration mechanism, 21—denitrification accelerator, 22—pH online monitor, 23—automatic lye dripping device, 24—H₂S detection alarm, 25—sulfur-based filler, 3—water circulation mechanism, 31—first water delivery pump, 32—first water delivery pipe, 321—first stop valve, 33—second water delivery pipe, 331—second stop valve, 34—second water delivery pump, 35—circulation control part, and 36—NO₃⁻ online monitor.

### DETAILED DESCRIPTION

The object of the present disclosure is realized by the following technical solutions.

An external acceleration system for a biological denitrification process during wastewater treatment is provided, including a biological denitrification mechanism, a denitrification acceleration mechanism, and a water circulation mechanism, where the biological denitrification mechanism includes a biological denitrification tank, a three-way valve, a wastewater assembly, and a water inlet pipe; the denitrification acceleration mechanism includes a denitrification accelerator and an assembly for enhancing the sulfur disproportionation reaction; the water circulation mechanism includes a first water delivery pump, a second water delivery pump, a first water delivery pipe, and a second water delivery pipe; a water inlet of the first water delivery pipe is connected to the biological denitrification tank, and a water outlet of the first water delivery pipe is connected to the denitrification accelerator; the first water delivery pump is connected to the first water delivery pipe, and the first water delivery pipe is mounted with a first stop valve; a water inlet of the second water delivery pipe is connected to the denitrification accelerator, and a water outlet of the second water delivery pipe is connected to a second water inlet of the three-way valve; a first water inlet of the three-way valve is connected to a water outlet of the wastewater assembly; a water outlet of the three-way valve is connected to a water inlet of the water inlet pipe, and a water outlet of the water inlet pipe is connected to the biological denitrification tank; the second water delivery pump is connected to the second water delivery pipe, and the second water delivery pipe is mounted with a second stop valve; the assembly for enhancing the sulfur disproportionation reaction is mounted on the denitrification accelerator or the first water delivery pipe.

Preferably, the denitrification accelerator is inoculated with sulfur-disproportionating bacteria, the denitrification accelerator is filled with a sulfur-based filler, and the biological denitrification tank is filled with a biological denitrification filler.

Preferably, the sulfur-disproportionating bacteria are microorganisms that use the intermediate-valence sulfur-containing compound or zero-valence sulfur to perform the autotrophic disproportionation reaction and generate sulfate and sulfide at the same time.

Preferably, the sulfur-based filler is elemental sulfur or a composite filler with elemental sulfur as a main component doped with other components.

More preferably, the other components include more than one iron salt, carbonate, bicarbonate, or sulfide mineral.

Preferably, the wastewater assembly includes wastewater pipes and wastewater pumps; a water inlet of the wastewater pipe is connected to a wastewater tank, and a water outlet of the wastewater pipe is connected to the first water inlet of the three-way valve; the wastewater pump is connected to the wastewater pipe.

Preferably, the biological denitrification tank is mounted with a water outlet pipe; a water inlet of the water outlet pipe is connected to the biological denitrification tank, and a water outlet of the water outlet pipe is connected to an external clean water tank; the water outlet pipe is mounted with a water outlet stop valve.

Preferably, the biological denitrification tank is arranged with an exhaust port.

Preferably, the biological denitrification tank is mounted with a water distributor, and the water distributor is located at the bottom of the biological denitrification filler.

Preferably, the denitrification accelerator is mounted with a water distributor, and the water distributor is located at the bottom of the sulfur-based filler.

Preferably, the assembly for enhancing the sulfur disproportionation reaction includes a pH online monitor and an automatic lye dripping device.

Preferably, the automatic lye dripping device contains carbonate solution or bicarbonate solution.

Preferably, the denitrification acceleration mechanism further includes an H₂S detection alarm, and the H₂S detection alarm is provided on the denitrification accelerator.

Preferably, the water circulation mechanism includes a NO₃⁻ online monitor, and the NO₃⁻ online monitor is connected to the biological denitrification tank.

Preferably, the water circulation mechanism further includes a circulation control part; a first signal input end of the circulation control part is connected to a NO₃⁻ online monitor, and a second signal input end of the circulation control part is connected to a pH online monitor; a first signal output end of the circulation control part is connected to an automatic lye dripping device, and a second signal output end of the circulation control part is connected to the first stop valve and the second stop valve.

Compared with the related art, the present disclosure has the following advantages and beneficial effects.

The external acceleration system for a biological denitrification process during wastewater treatment provided in the present disclosure spatially and temporally separates the sulfur disproportionation reaction process from the biological denitrification process so that the two processes do not interfere with each other and mutually promote the denitrification effect, which is beneficial to ensure the high efficiency and stability of the denitrification effect. The independently provided denitrification accelerator, releasing the coupling of the sulfur disproportionation reaction and the autotrophic denitrification reaction in the related art, has a high adaptability to various denitrification systems, which can not only serve for autotrophic denitrification, but also serve for main processes such as heterotrophic denitrification and mixotrophic denitrification, thus breaking the limitation of the application of the denitrification accelerator, improving the denitrification efficiency of the biological denitrification process during wastewater treatment, and reducing the addition cost of the organic carbon source and the carbon dioxide emission.

The sulfur-disproportionating bacteria require sufficient alkalinity and an anaerobic environment for growth and metabolism, while the denitrifying bacteria require an anoxic environment for growth. Independently providing the denitrification acceleration mechanism may prevent nitrate from increasing a redox potential in aqueous solution and thus changing the environment of the system, and avoid the disadvantages of mutual interference of the two bacteria in the same system, which is beneficial to the growth and metabolic activity of the sulfur-disproportionating bacteria and the generation of Sₙ²⁻, providing optimal conditions for the two bacteria separately to realize the simultaneous acceleration of the denitrification reaction and the sulfur disproportionation reaction.

The external acceleration system for a biological denitrification process during wastewater treatment is highly self-controlled, and the pH of the denitrification accelerator is automatically monitored. According to a target denitrification rate and a real-time calculation result of the sulfur disproportionation mathematical model, the denitrification accelerator automatically optimizes and adjusts pH to 8-10 and the water inlet flow rate, thus, the sulfur disproportionation reaction rate and the soluble electron donor yield can be controlled automatically.

The object of the present disclosure will be described in further detail below in conjunction with the accompanying drawings and specific embodiments. The embodiments cannot be repeated here, but the implementations of the present disclosure are not limited to the following embodiments.

### Embodiment 1

An external acceleration system for a biological denitrification process during wastewater treatment is provided, including a biological denitrification mechanism 1, a denitrification acceleration mechanism 2, and a water circulation mechanism 3. The biological denitrification mechanism 1 includes a biological denitrification tank 11, a water outlet pipe 12, a three-way valve 13, a wastewater assembly 14, a water inlet pipe 15, a biological denitrification filler 16, and an exhaust port 17. The denitrification acceleration mechanism 2 includes a denitrification accelerator 21, an assembly for enhancing the sulfur disproportionation reaction, an H₂S detection alarm 24, and a sulfur-based filler 25. The water circulation mechanism 3 includes a first water delivery pump 31, a first water delivery pipe 32, a second water delivery pipe 33, a second water delivery pump 34, a circulation control part 35, and a NO₃⁻ online monitor 36. The wastewater assembly 14 includes a wastewater pipe 141 and a wastewater pump 142. The assembly for enhancing the sulfur disproportionation reaction includes a pH online monitor 22 and an automatic lye dripping device 23. The water outlet pipe 12, the first water delivery pipe 32, and the second water delivery pipe 33 are mounted with a water outlet stop valve 121, a first stop valve 321, and a second stop valve 331, respectively.

A water distributor is mounted at the bottom end of the interior of the biological denitrification tank 11, the interior of the biological denitrification tank 11 is filled with the biological denitrification filler 16, and the water distributor is located at the bottom of the biological denitrification filler 16. The exhaust port 17 is arranged at the upper left corner of the top of the biological denitrification tank 11. A water inlet at the outer bottom end of the biological denitrification tank 11 is connected to a water outlet of the water inlet pipe 15, and a water inlet of the water inlet pipe 15 is connected to a water outlet of the three-way valve 13. The first water inlet of the three-way valve is connected to a water outlet of the wastewater pipe 141, and a water inlet of the wastewater pipe 141 is connected to a wastewater tank. The wastewater pump 142 is connected to the wastewater pipe 141. The wastewater in the wastewater tank is pumped into the biological denitrification tank 11 through the action of the wastewater pump 142. After the wastewater enters the biological denitrification tank 11, the water distributor uniformly disperses the wastewater. The wastewater flows into the biological denitrification filler 16 from bottom to top to reduce the nitrate in the wastewater to N₂, and N₂ is discharged from the top exhaust port 17.

The water outlet pipe 12 is mounted on the left side surface of the biological denitrification tank 11, and the water outlet pipe is mounted with the water outlet stop valve 121. A water inlet of the water outlet pipe 12 is connected to the biological denitrification tank 11, and a water outlet of the water outlet pipe 12 is connected to an external clean water tank. The treated water is discharged into the clean water tank.

The NO₃⁻ online monitor 36 is provided inside the biological denitrification tank 11. The NO₃⁻ online monitor 36 is connected to the first signal input end of the circulation control part 35, and a second signal output end of the circulation control part 35 is connected to the first stop valve 321 on the first water delivery pipe 32 and the second stop valve 331 on the second water delivery pipe 33. The circulation control part 35 determines whether to continue the reflux by monitoring the concentration of NO₃⁻ in the wastewater.

An outer top end of the biological denitrification tank 11 is arranged with a water outlet which is connected to a water inlet of the first water delivery pipe 32. The first water delivery pump 31 is connected to the first water delivery pipe 32. A water outlet of the first water delivery pipe 32 is connected to a water inlet at an outer bottom end of the denitrification accelerator 21, and wastewater after the denitrification reaction is delivered to the denitrification accelerator 21 through a pumping action.

The denitrification accelerator 21 is filled with sulfur-based filler 25 and inoculated with sulfur-disproportionating bacteria. The sulfur-disproportionating bacteria are microorganisms that use an intermediate-valence sulfur-containing compound or zero-valence sulfur as a reactant to perform an autotrophic disproportionation reaction under suitable conditions and generate sulfate and sulfide at the same time. The sulfur-based filler is elemental sulfur or a composite filler with elemental sulfur as the main component doped with other components. The other components include more than one iron salt, carbonate, bicarbonate, or sulfide mineral. The pH online monitor 22, the automatic lye dripping device 23, and the H₂S detection alarm 24 are successively mounted on the outer top end of the denitrification accelerator 21 from left to right. In addition, the pH online monitor 22 and the automatic lye dripping device 23 may also be mounted at the first water delivery pipe 32. A second signal input end of the circulation control part 35 is connected to the pH online monitor 22, and a first signal output end of the circulation control part 35 is connected to the automatic lye dripping device 23. The automatic lye dripping device 23 contains carbonate solution or bicarbonate solution to adjust the alkalinity of the wastewater. When the wastewater flows from the biological denitrification tank, the sulfur-disproportionating bacteria generate a suitable amount of sulfide, and then continuously convert the elemental sulfur into Sₙ²⁻. The alkalinity of the wastewater is regulated, the degree of the sulfur disproportionation reaction is controlled, and the concentration of sulfide outside the denitrification acceleration mechanism 2 is monitored in real-time so that the operation safety of the system is ensured.

The second water delivery pump 34 is connected to the second water delivery pipe 33, and the second water delivery pipe 33 is mounted with the second stop valve 331. A water outlet of the second water delivery pipe 33 is connected to a second water inlet of the three-way valve 13, and the three-way valve 13 is connected to a water inlet at the bottom of the biological denitrification tank 11 through the water inlet pipe 15. The sulfide and Sₙ²⁻ generated by the sulfur disproportionation reaction are delivered to the biological denitrification tank 11 through reflux to provide sufficient and efficient soluble electron donors (HS⁻ and Sₙ²⁻) for denitrification to form nitrate reduction mediated by multiple electron donors, thereby realizing rapid reduction and removal of nitrate in the biological denitrification tank 11.

The wastewater from the wastewater tank enters the biological denitrification tank 11 through the wastewater pipe 141 under the action of the wastewater pump 142. The water distributor at the lower end of the biological denitrification tank 11 uniformly disperses the wastewater. The wastewater flows into the biological denitrification filler 16 from bottom to top, and the nitrate in the wastewater reacts with the biological denitrification filler 16 by denitrification reaction so that the nitrate is reduced to N₂ in the biological denitrification tank 11, and then N₂ is discharged from the top exhaust port 17. After the wastewater undergoes the denitrification reaction, the circulation control part 35 opens the first stop valve 321, and the wastewater flows into the denitrification accelerator 21 through the first water delivery pipe 32 under the action of the first water delivery pump 31. The denitrification accelerator 21 is filled with the sulfur-based filler 25 and inoculated with the sulfur-disproportionating bacteria, which performs sulfur disproportionation reaction under suitable conditions. The sulfur-disproportionating bacteria generate a suitable amount of sulfide, and then continuously convert the elemental sulfur into Sₙ²⁻. When the pH online monitor 22 detects that the pH value of the wastewater in the denitrification accelerator 21 is lower than 8.0, a signal is transmitted to the circulation control part 35, the circulation control part 35 starts the automatic lye dripping device 23 to adjust the alkalinity until the pH value of the wastewater detected by the pH online monitor 22 reaches 10.0, and the circulation control part turns off the automatic lye dripping device 23. The denitrification accelerator 21 is tightly sealed to avoid the risk of sulfide oxidation loss and leakage. The H₂S detection alarm 24 is installed on the denitrification accelerator 21 to monitor the concentration of sulfide outside the denitrification acceleration mechanism in real-time to ensure the operation safety of the system. After the sulfur disproportionation reaction, the circulation control part 35 opens the second stop valve, and the sulfide and Sₙ²⁻ generated by the sulfur disproportionation reaction are delivered to the biological denitrification tank through the second water delivery pipe 33 to provide sufficient and efficient soluble electron donors (HS⁻ and Sₙ²⁻) for denitrification to form nitrate reduction mediated by multiple electron donors, thereby realizing rapid reduction and removal of nitrate in the biological denitrification tank. When the NO₃⁻ online monitor 36 monitors that the concentration of NO₃ is high, a signal is transmitted to the circulation control part 35, and the circulation control part 35 opens the first stop valve 321 to perform reflux and starts the automatic lye dripping device 23 through the first signal output end to maintain the pH of the denitrification accelerator at a level above 8.5 to promote the sulfur disproportionation reaction to efficiently generate a sufficient amount of sulfide and Sₙ²⁻. Then, the wastewater rich in sulfide and Sₙ²⁻ is delivered to the biological denitrification tank 11 through the second water delivery pipe 33 to accelerate the removal of NO₃⁻ and ensure the efficient denitrification of the biological denitrification tank 11. The purified wastewater is discharged to the clean water tank through the water outlet pipe 12.

The external acceleration system for a biological denitrification process during wastewater treatment of the present disclosure can be applied to a variety of scenarios, such as advanced denitrification treatment in a municipal wastewater treatment plant, underground water purification polluted by nitrate nitrogen, nitrate nitrogen-containing industrial wastewater treatment, and denitrification of landfill leachate.

The above-mentioned specific implementations are preferred embodiments of the present disclosure and cannot limit the present disclosure. Any other changes or equivalent substitutions made without departing from the technical solutions of the present disclosure are included in the scope of the present disclosure.

We claim:

1. An external acceleration system for a biological denitrification process during wastewater treatment, comprising a biological denitrification mechanism (1), a denitrification acceleration mechanism (2), and a water circulation mechanism (3), wherein the biological denitrification mechanism (1) comprises a biological denitrification tank (11), a three-way valve (13), a wastewater assembly (14), and a water inlet pipe (15); the denitrification acceleration mechanism (2) comprises a denitrification accelerator (21) and an assembly for enhancing the sulfur disproportionation reaction; the water circulation mechanism (3) comprises a first water delivery pump (31), a first water delivery pipe (32), a second water delivery pipe (33), and a second water delivery pump (34); a water inlet of the first water delivery pipe (32) is connected to the biological denitrification tank (11), and a water outlet of the first water delivery pipe (32) is connected to the denitrification accelerator (21); the first water delivery pump (31) is connected to the first water delivery pipe (32), and the first water delivery pipe (32) is mounted with a first stop valve (321); a water inlet of the second water delivery pipe (33) is connected to the denitrification accelerator (21), and a water outlet of the second water delivery pipe (33) is connected to a second water inlet of the three-way valve (13); a first water inlet of the three-way valve (13) is connected to a water outlet of the wastewater assembly (14); a water outlet of the three-way valve (13) is connected to a water inlet of the water inlet pipe (15), and a water outlet of the water inlet pipe (15) is connected to the biological denitrification tank (11); the second water delivery pump (34) is connected to the second water delivery pipe (33), and the second water delivery pipe (33) is mounted with a second stop valve (331); the assembly for enhancing the sulfur disproportionation reaction is mounted on the denitrification accelerator (21) or the first water delivery pipe (32).

2. The external acceleration system for a biological denitrification process during wastewater treatment according to claim 1, wherein the denitrification accelerator (21) is inoculated with sulfur-disproportionating bacteria, the denitrification accelerator (21) is filled with a sulfur-based filler (25), and the biological denitrification tank (11) is filled with a biological denitrification filler (16).

3. The external acceleration system for a biological denitrification process during wastewater treatment according to claim 1, wherein the sulfur-disproportionating bacteria are microorganisms that use the intermediate-valence sulfur-containing compound or zero-valence sulfur to perform an autotrophic disproportionation reaction and generate sulfate and sulfide at the same time.

4. The external acceleration system for a biological denitrification process during wastewater treatment according to claim 1, wherein the wastewater assembly (14) comprises a wastewater pipe (141) and a wastewater pump (142); a water inlet of the wastewater pipe (141) is connected to a wastewater tank, and a water outlet of the wastewater pipe (141) is connected to the first water inlet of the three-way valve (13); the wastewater pump (142) is connected to the wastewater pipe (141).

5. The external acceleration system for a biological denitrification process during wastewater treatment according to claim 1, wherein the biological denitrification tank (11) is mounted with a water outlet pipe (12); a water inlet of the water outlet pipe (12) is connected to the biological denitrification tank (11), and a water outlet of the water outlet pipe (12) is connected to an external clean water tank; the water outlet pipe (12) is mounted with a water outlet stop valve (121).

6. The external acceleration system for a biological denitrification process during wastewater treatment according to claim 1, wherein the biological denitrification tank (11) is arranged with an exhaust port (17).

7. The external acceleration system for a biological denitrification process during wastewater treatment according to claim 1, wherein the assembly for enhancing the sulfur disproportionation reaction comprises a pH online monitor (22) and an automatic lye dripping device (23).

8. The external acceleration system for a biological denitrification process during wastewater treatment according to claim 1, wherein the water circulation mechanism (3) comprises a NO₃⁻ online monitor (36), and the NO₃⁻ online monitor (36) is mounted in the biological denitrification tank (11).

9. The external acceleration system for a biological denitrification process during wastewater treatment according to claim 1, wherein the water circulation mechanism (3) further comprises a circulation control part (35); a first signal input end of the circulation control part (35) is connected to a NO₃⁻ online monitor (36), and a second signal input end of the circulation control part (35) is connected to a pH online monitor (22); a first signal output end of the circulation control part (35) is connected to an automatic lye dripping device (23), and a second signal output end of the circulation control part (35) is connected to the first stop valve (321) and the second stop valve (331).
